(19) United States
(12) Patent Application Publication
(10) Pub. No.: US 2014/0214784 A1
(43) Pub. Date: Jul. 31, 2014

(54) APPARATUS FOR PROVIDING TRANSACTION SHARING HYBRID INTERFACE OF SESSION

(71) Applicant: Altibase Corp., Seoul (KR)

(72) Inventors: Won Seo, Gyeonggi-do (KR); Moon Hee Lee, Seoul (KR); Joon Ho Park, Seoul (KR); Jeong Shik Choi, Gyeonggi-do (KR)

(73) Assignee: Altibase Corp., Seoul (KR)

(21) Appl. No.: 14/090,549

(22) Filed: Nov. 26, 2013

(30) Foreign Application Priority Data
Jan. 28, 2013 (KR) 10-2013-0009455

(51) Int. Cl. G06F 17/30

(52) U.S. Cl. CPC G06F 17/30424
USPC 707/703

(57) ABSTRACT

Provided is an apparatus for providing a transaction sharing hybrid interface of a session. The hybrid interface includes a direct interface, of an imperative application programming interface (API), which retrieves or modifies data in database tables by bypassing a query processor (QP) layer and directly accessing a storage manager (SM) layer, and a SQL interface, of a declarative API, which retrieves or modifies data in database tables by going through the query processor layer before accessing the storage manager layer. From among one or more queries in one transaction of a session, the direct interface performs simple queries, and the SQL interface performs queries other than the simple queries.

### CROSS-REFERENCE TO RELATED PATENT APPLICATION

This application claims the benefit of Korean Patent Application No. 10-2013-0009455, filed on Jan. 28, 2013, in the Korean Intellectual Property Office, the disclosure of which is incorporated herein in its entirety by reference.

### BACKGROUND OF THE INVENTION

1. Field of the Invention

The present invention relates to a database management system (DBMS), and more particularly, to a database management system using a transaction sharing hybrid interface of a session.

2. Description of the Related Art

A database management system (DBMS) at an early stage provided an imperative application programming interface (API) for retrieving or modifying data in database tables. The imperative API has the merit of high speed, and is appropriate for a simple data model and logic.

However, such an imperative API has problems in that, when logic of an application is complex as, for example, in joining multiple tables with a complex data model, development time and costs increase, and furthermore, in the case where there is a change in a data model, the application has to be modified considerably, thereby increasing maintenance costs as well. In an attempt to solve these problems, a modern database management system (DBMS) adopts a declarative API like a structured query language (SQL) interface. However, the SQL interface's processing cost for a simple query is considerably high with respect to gross operation costs, thus causing database system performance to degrade.

Korean Patent Laid-open Publication No. 2006-0019439 was disclosed as related art.

### SUMMARY OF THE INVENTION

According to an embodiment of the present invention, there is provided a solution for overcoming problems of database system performance degradation caused by using a structured query language (SQL) interface especially in handling a simple query in a conventional database management system (DBMS).

According to another embodiment of the present invention, out of one or more queries in one transaction of a session, there are provided different interfaces according to characteristics of each query. A query may be understood as a database transaction that can result in distinct units of work being performed to one or more records of the database, such as a read command, write command, delete command, or add command It may be possible to roll back such database transactions.

In an embodiment of the present invention, there is provided a hybrid interface in order to solve the above-described problems, in which with the hybrid interface, from among queries in one transaction of a session, simple queries are processed in a direct interface which is an imperative application programming interface (API), and complex queries are processed in a SQL interface which is a declarative API. Simple queries and complex queries may be classified based on their characteristics, such as whether a query could execute operation within a particular table or not, as well as based on one or more predefined rules, which can be set by a user. Usually, simple queries are queries that are fit for executing operations within a particular table.

Preferably, both the SQL interface and the direct interface are configured to retrieve or modify data in database tables through a storage manager (SM) layer which stores and updates a database of a DBMS. A query processor (QP) makes an execution plan of a SQL or selects an appropriate existing execution plan of a SQL. The direct interface bypasses a QP layer and goes directly through a storage manager (SM) layer. However, the SQL interface has to go through a query processor layer before going to a storage manager (SM) layer.

Preferably, the hybrid interface is not limited to a specific communication or memory access method to access a database including a transmission control protocol/internet protocol (TCP/IP), inter-process communication (IPC), direct memory access of the database memory, etc.

Preferably, the implementation of the hybrid interface is not limited to a specific computer programming language including C language, JAVA language, etc.

Preferably, the transaction keeps logs of undo and redo operations of operations executed by the transaction, as well as lock information of objects updated by the transaction.

### BRIEF DESCRIPTION OF THE DRAWINGS

FIG. 1 is a block diagram illustrating execution of multiple queries of one transaction of a session in a database management system (DBMS), according to an embodiment of the present invention;

FIG. 2 is a block diagram illustrating a hybrid interface that is implemented so that a client application accesses data in a database, according to an embodiment of the present invention;

FIG. 3 is a block diagram illustrating execution of multiple queries of one transaction of a session in an apparatus for providing a transaction sharing hybrid interface of a session, according to an embodiment of the present invention; and

FIG. 4 is a flowchart illustrating implementation of a hybrid interface in an apparatus for providing a transaction sharing hybrid interface of a session, according to an embodiment of the present invention;

FIG. 5 illustrates an embodiment of a method for using a hybrid interface to perform multiple queries in a single transaction; and

FIG. 6 illustrates an embodiment of a computer system, which may be used in performing the flowcharts and methods detailed herein.

### DETAILED DESCRIPTION OF THE INVENTION

Referring to the attached drawings, an embodiment of the present invention will be explained in detail below.

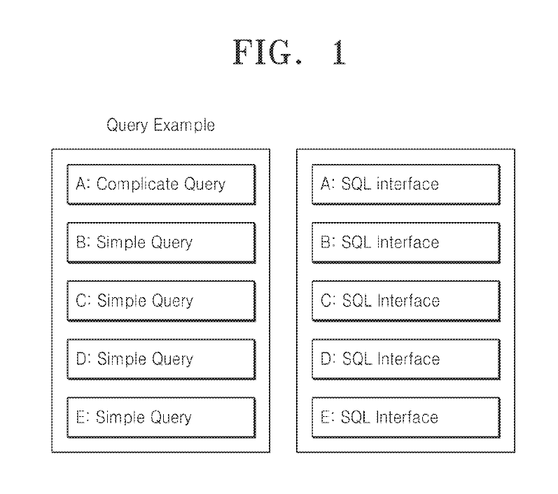

FIG. 1 is a block diagram illustrating execution of multiple queries of one transaction of a session in a database management system (DBMS), according to an embodiment of the present invention.

A database management system provides functions such as adding, modifying, deleting, and retrieving data and a database is accessed by multiple application programs.

A client, such as a client application program executing on a client computer system, performs multiple queries in one transaction of a session. The transaction may be with a remote server system executing a DBMS. For instance, if one transaction consists of queries A, B, C, D, and E as in FIG. 1, even if queries B, C, D, and E are simple, all the queries A, B, C, D, and E have to use a structured query language (SQL) interface in order to perform a complex query A.

As a result, the gross operation costs increase and database performance degrades due to using a SQL interface especially in performing simple queries.

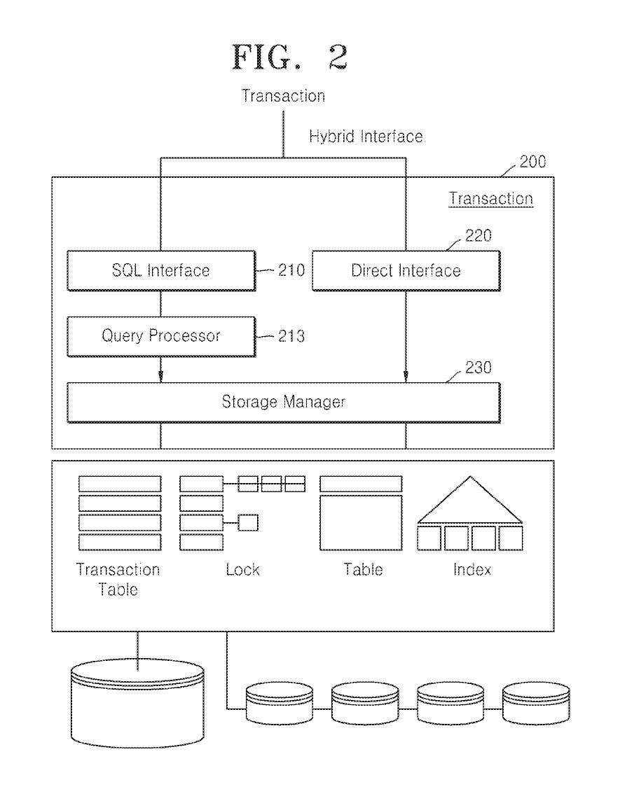

FIG. 2 is a block diagram illustrating an apparatus 200 for providing a transaction sharing hybrid interface of a session according to an embodiment of the present invention.

The hybrid interface includes a SQL interface 210 and a direct interface 220. It is decided by the client application program whether to use a SQL interface 210 or a direct interface 220 based on the characteristics of input queries or based on one or more predefined rules, which may be set by a user.

Both the SQL interface 210 and the direct interface 220 retrieve or modify data in database tables through a layer of a storage manager (SM) 230. The storage manager layer 230 retrieves or modifies data in database tables through transaction objects, and the transaction objects are shared between the SQL interface 210 and the direct interface 220. A transaction object may be an inner structure providing the features of a transaction with the DBMS. For example, a transaction object can include a session id, a transaction id, an SQL statement id, lock information, redo log information, and undo log information.

Thus, the SQL interface 210 or the direct interface 220 commits or rolls back one or more operation (e.g. insert, update, and delete) results together, which are produced from each of the SQL interface 210 and the direct interface 220. A transaction can be understood as a “unit of work”, thus one or more SQL statements in a same transaction such as a commit and rolling back can be combined together.

More specifically, a transaction keeps logs of undo and redo operations of operations executed by the transaction, as well as lock information of objects updated by the transaction. A transaction keeps from editing the data being edited by other transaction by referring the lock information. The lock information includes record lock information.

Therefore, in the case of rollback operations executed by sharing transaction objects between the SQL interface 210 and the direct interface 220, undo is implemented by using undo log information of the transaction. A commit operation is implemented by using redo log information of the transaction. Therefore, queries that are part of the same transaction are committed or rolled back together.

Functions of each of the SQL interface 210 and the direct interface 220 are as follows:

The SQL interface 210 accesses the storage manager layer 230, through a query processor layer 213, and retrieves and modifies data in database tables, such as via declarative programming techniques.

The SQL interface 210 is configured to retrieve and modify data in database tables using the SQL, that is, a declarative application programming interface (API).

The direct interface 220 supports to directly retrieve or modify data in database tables using storage manager layer 230 without going through the query processor layer 213. In order to process an SQL query, the QP (query processor) layer can make a query plan and performs a query execution based on the query plan. The query plan can operate by calling the SM layer. By contrast, the QP layer may not be called if a client application calls the SM layer. Thus, the query plan may not be made. For this reason, via direct interface 220, the user should set the information such as table name, column names, index name, index search conditions, and filter conditions, which are automatically made in the query plan.

The direct interface 220 has an advantage of fast performance since the direct interface 220 does not pass through a query processor layer in the database management system (DBMS), but is directly accessing the storage manager layer 230.

The direct interface 220 of FIG. 2 is configured to process simple queries using an imperative API.

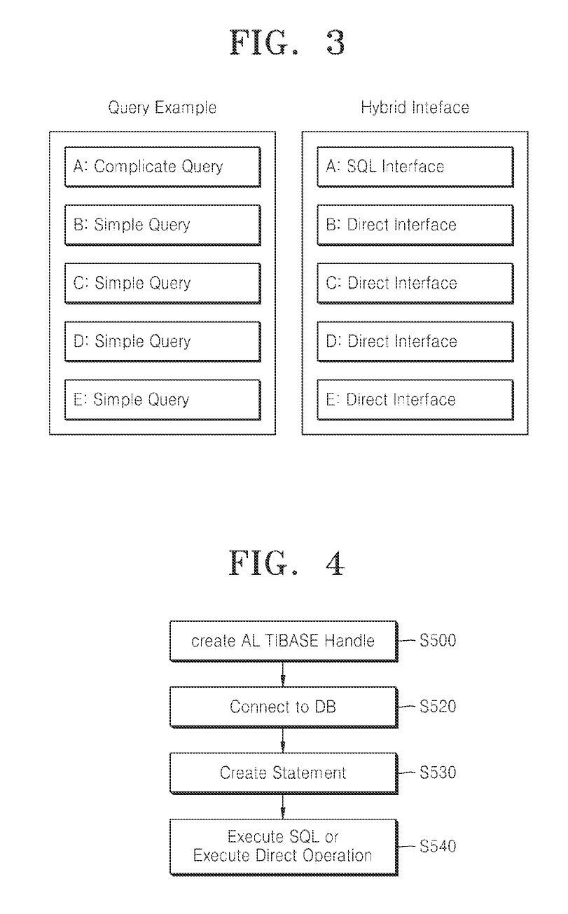

FIG. 3 is a block diagram illustrating an execution of one transaction of a session in an apparatus for providing a transaction sharing hybrid interface of a session, according to an embodiment of the present invention.

When one transaction includes five queries: queries A, B, C, D, and E, a complex query A is performed in a SQL interface, and queries B, C, D, and E are performed in a direct interface. Such a determination on which interface is used may be based on characteristics of the input query and/or one or more predetermined rules set by user.

Since, in an apparatus for providing a transaction sharing hybrid interface of a session, the query A performed by the SQL interface 210 of FIG. 2 and the queries B, C, D, and E performed by the direct interface 220 of FIG. 2 can be executed in one sharing transaction of a session, processed results of the query A performed in the SQL interface 210 of FIG. 2 and processed results of queries B, C, D, and E performed in the direct interface 220 of FIG. 2 can together be committed or rolled back.

Because the direct interface 220 bypasses the query processor layer 213, the direct interface 220 needs more information which the SQL interface 210 does not need. For example, such information may include index-name and index-search-conditions and filter-conditions.

FIG. 4 is a flowchart illustrating implementation of a hybrid interface in an apparatus for providing a transaction sharing hybrid interface of a session, according to an embodiment of the present invention.

It should be noted that the interface may be modified in various forms by a person of ordinary skill in the art of the present invention.

A session is made by creation of a connection handle in operation S500. The session uses both the SQL interface and the direct interface. A hybrid interface is used to execute operations S500, S520 and S530. The hybrid interface uses mixed interfaces of a direct interface and a SQL interface to execute operation S540.

Also, according to an embodiment of the present invention, a transaction sharing hybrid method in a session can be realized through computer-readable codes on a non-transitory computer-readable recording medium. Computer-readable recording mediums include all kinds of storage devices where computer system-readable data are stored. Examples of computer-readable recording mediums are ROM, RAM, CO-ROM, magnetic tapes, floppy disks, and optical data storage devices, etc. Computer-readable recording media can store and execute computer-readable codes to be distributed throughout network-connected computer systems.

By using a transaction sharing hybrid method of a session, a database performance degradation problem caused by processing loads due to the exclusive use of a declarative API such as a SQL interface to perform multiple queries consisting of simple and complex queries in one transaction of a session is solved. Also, drawbacks such as an increase in a coding amount during development due to exclusive use of a direct interface which is an imperative API are also overcome.

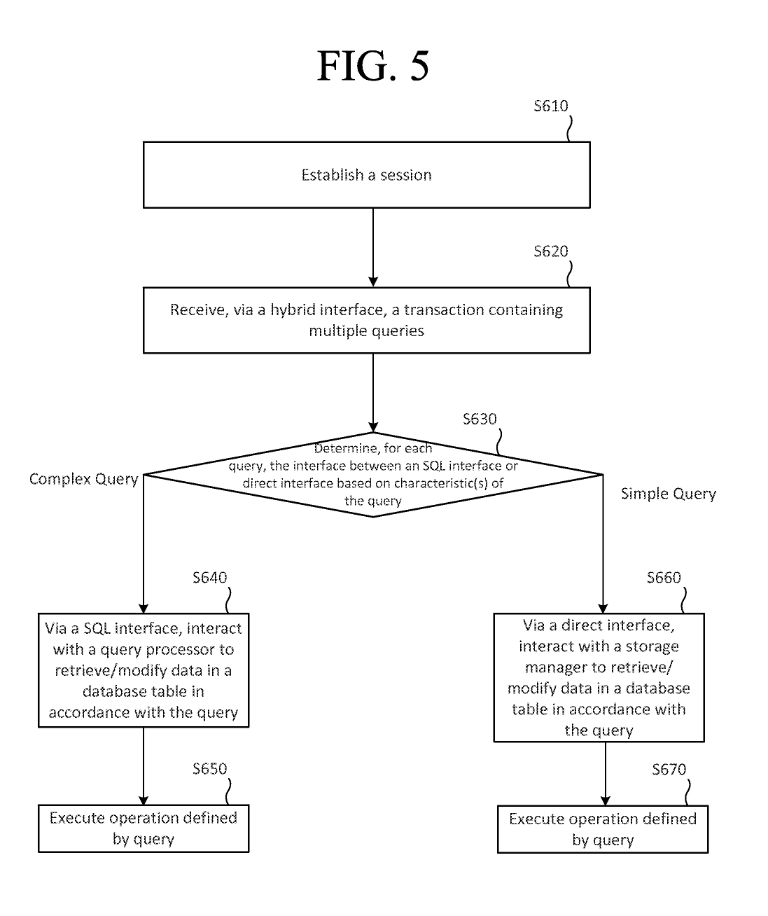

FIG. 5 illustrates an embodiment of a method 600 for using a hybrid interface to perform multiple queries in a single transaction of a session. To perform method 600, one or more computer systems may be used to perform each step. For instance, a computer system locally operated by a user may be used. In some embodiments, a user may interact with a remote server via a client computer system across a network. In such embodiments, the remote server may perform some or all of the steps of method 600. At step S610, a session may be established with a hybrid interface. The hybrid interface may be configured to handle queries from the same session using either a SQL interface or a direct interface, depending on the content of each specific query. As such, the hybrid interface may handle one or more queries from a single transaction of a session using a SQL interface while one or more other queries are handled using a direct interface. If possible, as many queries as possible may be handled using the direct interface due to such queries likely being executed faster.

At step S620, via the hybrid interface, a single transaction is received that contains multiple queries. For instance two, three, or more queries may be received that are part of the same transaction of a session. At step S630, based on whether each query is simple or complex, either a SQL interface or a direct interface may be used for interaction with a storage manager. The determination of whether a query is simple or complex may be based on predefined rules and/or one or more characteristics of the queries. A simple request may be appropriate to be handled by a direct interface. For instance, a simple request may specify information such as an index name, index search conditions, and filter conditions.

For a complex query from the transaction, the complex query is submitted via an SQL interface at step S640. The SQL interface is configured to interact with a query processor layer to retrieve or modify data in a database table accessible via a storage manager. At step S650, the operation defined by the query executed via the SQL interface and the query processor layer is executed and, possibly, a result is returned.

For a simple query from the transaction, the simple query is submitted via a direct interface at S660. The direct interface may require more information to frame the query than the SQL interface. Further, the direct interface does not require the use of a query processor. Rather, the direct interface may be configured to interact directly with the storage manager. At S670, the operation defined by the query executed via the direct interface (without the query processor) is executed and, possibly, a result is returned.

In some embodiments, since the queries were performed as part of a single transaction, regardless that separate interfaces may have been used, these queries are committed together, or, can be rolled back together.

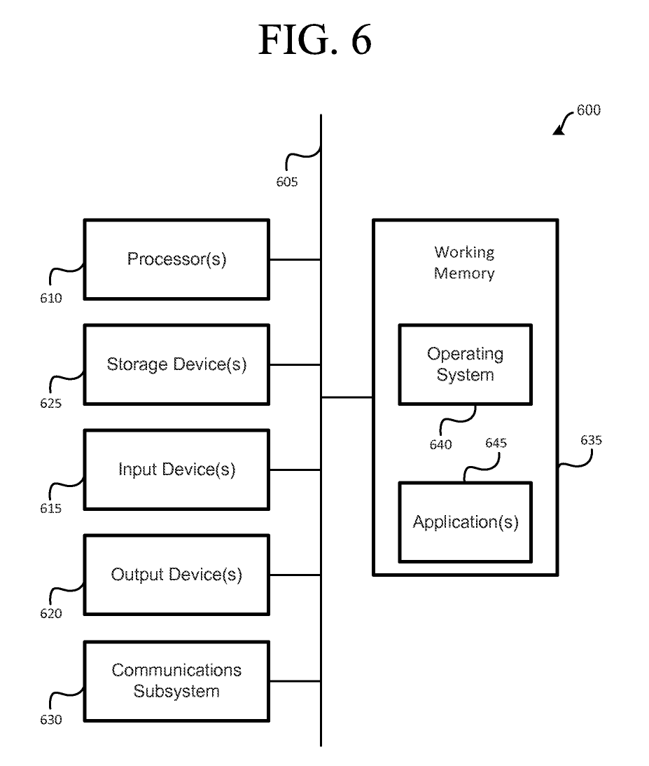

FIG. 6 illustrates an embodiment of a computer system. A computer system as illustrated in FIG. 6 may be incorporated as part of the previously described computerized devices, such as the one or more computer systems used to perform the methods (also indicated as flowcharts) of FIGS. 4 and 5. FIG. 6 provides a schematic illustration of one embodiment of a computer system 700 that can perform various steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, video decoders, and/or the like); one or more input devices 715, which can include without limitation a mouse, a keyboard, remote control, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth device, an 802.11 device, a WiFi device, a WiMax device, cellular communication device, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 might cause the processor(s) 710 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

It should further be understood that the components of computer system 700 can be distributed across a network. For example, some processing may be performed in one location using a first processor while other processing may be performed by another processor remote from the first processor. Other components of computer system 700 may be similarly distributed. As such, computer system 700 may be interpreted as a distributed computing system that performs processing in multiple locations. In some instances, computer system 700 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

While the present invention has been particularly shown and described with reference to exemplary embodiments thereof, it will be understood by those of ordinary skill in the art that various changes in form and details may be made therein without departing from the spirit and scope of the present invention. Therefore, the disclosed embodiments are not to be interpreted in a restrictive manner, but in an expository manner. The scope of the present invention is disclosed in the scope of the claim, not in the description above. Also, any difference within the equivalent scope must be considered to be included in the present invention.

What is claimed is:

1. An apparatus for providing a transaction sharing hybrid interface of a session, the apparatus comprising:
a direct interface, of an imperative application programming interface (API), which directly accesses a storage manager (SM) layer and retrieves or modifies data in database tables; and
a structured query language (SQL) interface, of a declarative API, which accesses the storage manager layer through a query processor layer and retrieves or modifies data in database tables,
wherein, from among one or more queries in one transaction of a session, the direct interface performs simple queries, and
from among the one or more queries in the one transaction of a session, the SQL interface performs queries other than the simple queries.

2. The apparatus of claim 1, wherein both the SQL interface and the direct interface access or update data through the storage manager (SM) layer which retrieves or updates data in tables of a database management system (DBMS).

3. The apparatus of claim 1, wherein the SQL interface or the direct interface commits or rolls back one or more operation results together, which are produced from each of the SQL interface and the direct interface.

4. The apparatus of claim 2, wherein the storage manager layer updates data through transaction objects, and the transaction objects are shared between the SQL interface and the direct interface in a session.

5. The apparatus of claim 1, wherein the SQL interface and the direct interface share the transaction objects,
in a case of committing a transaction of a session which maintains operations executed by the SQL interface or the direct interface, a commit operation is performed by using redo log information of the transaction, and
in a case of rolling back a transaction of a session which maintains operations executed by the SQL interface or the direct interface, an undo operation is performed by using undo log information of the transaction.

6. A method for performing a transaction during a session, the method comprising:
receiving, by a computer system, a transaction during the session, wherein the transaction comprises a plurality of queries;
accessing, by the computer system, based on the transaction, a storage manager (SM) via a direct interface for a first subset of the plurality of queries, wherein the storage manager is accessed to retrieve or modify data in one or more database tables in response to each query of the first subset of queries; and
accessing, by the computer system, based on the transaction, the storage manager via a structured query language (SQL) interface of a declarative application programming interface (API) for a second subset of the plurality of queries, wherein the storage manager is accessed to retrieve or modify data in one or more database tables in response to each query of the second subset of queries.

7. The method for performing the transaction during the session of claim 6, wherein both the SQL interface and the direct interface access or update data through the storage manager that retrieves or updates data in the one or more database tables of a database management system (DBMS).

8. The method for performing the transaction during the session of claim 6, the method further comprising:
performing, by the computer system via the SQL interface and the direct interface, roll backs of one or more operation results of the plurality of queries together.

9. The method for performing the transaction during the session of claim 6, the method further comprising:
updating, by the computer system, via the storage manager the one or more database tables using one or more transaction objects, wherein the transaction objects are shared between the SQL interface and the direct interface in the session.

10. The method for performing the transaction during the session of claim 6, wherein the SQL interface and the direct interface share transaction objects; the method further comprising:
performing, by the computer system, a commit operation using redo log information of the transaction.

11. The method for performing the transaction during the session of claim 6, wherein the SQL interface and the direct interface share transaction objects; the method further comprising:
performing, by the computer system, an undo operation using undo log information of the transaction.

12. A non-transitory processor-readable medium for performing a transaction during a session, comprising processor-readable instructions configured to cause one or more processors to:
receive a transaction during the session, wherein the transaction comprises a plurality of queries;
access, based on the transaction, a storage manager (SM) via a direct interface for a first subset of the plurality of queries, wherein the storage manager is accessed to retrieve or modify data in one or more database tables in response to each query of the first subset of queries; and
access based on the transaction, the storage manager via a structured query language (SQL) interface of a declarative application programming interface (API) for a second subset of the plurality of queries, wherein the storage manager is accessed to retrieve or modify data in one or more database tables in response to each query of the second subset of queries.

13. The non-transitory processor-readable medium for performing the transaction during the session of claim 12, wherein both the SQL interface and the direct interface access or update data through the storage manager that retrieves or updates data in the one or more database tables of a database management system (DBMS).

14. The non-transitory processor-readable medium for performing the transaction during the session of claim 12, wherein the processor-readable instructions are further configured to cause the one or more processors to:
perform, by the SQL interface and the direct interface, roll backs of one or more operation results of the plurality of queries together.

15. The non-transitory processor-readable medium for performing the transaction during the session of claim 12, wherein the processor-readable instructions are further configured to cause the one or more processors to
update, via the storage manager, the one or more database tables using one or more transaction objects, wherein the transaction objects are shared between the SQL interface and the direct interface in the session.
